(19) United States
(12) Patent Application Publication
(10) Pub. No.: US 2019/0129589 A1
(43) Pub. Date: May 2, 2019

(54) Personalized Interaction and Navigation System

(71) Applicant: salesforce.com, inc., San Francisco, CA (US)

(72) Inventors: Joseph Ryan, San Francisco, CA (US); David M. Brady, Oakland, CA (US); Yon Aran Rhee, Bainbridge Island, WA (US); Mary Elizabeth Clarke, Oakland, CA (US); Mabel Sze Chan, San Francisco, CA (US); Simon Taggart, San Francisco, CA (US); Jesse Hausler, San Francisco, CA (US); Justin Spadea, Durham, NC (US); Mehak Kapur, San Francisco, CA (US); Mike Alsup, Rochester, NY (US); Nithyanandniranjan Chandarraj, Sunnyvale, CA (US); Peter Abelseth, Minneapolis, MN (US); Gustavo Souza, Santa Monica, CA (US); Ruchi Agarwal, Fremont, CA (US); Brian Donnelly, Portland, OR (US)

(73) Assignee: salesforce.com, inc., San Francisco, CA (US)

(21) Appl. No.: 15/884,684

(22) Filed: Jan. 31, 2018

Related U.S. Application Data
(60) Provisional application No. 62/579,582, filed on Oct. 31, 2017.

(51) Int. Cl. G06F 3/0483

(52) U.S. Cl. CPC G06F 3/0483; H04L 67/10

(57) ABSTRACT

Disclosed herein are system, method, and computer program product embodiments providing a personalized interaction and navigation system. An embodiment operates by receiving, during a computing session, an indication of a first interaction with a currently accessed document stored in a computing system. It is determined that the first document is not included in the set of previously accessed documents. A new tab is added to the interface corresponding to the currently accessed document based upon the determining. The new tab is maintained on the interface for the duration of the computing session, wherein upon completion of the computing session, a determination is made whether to persist the tab beyond the computing session based on a request or to automatically remove the tab from the interface and the cache.

### CROSS REFERENCE TO RELATED APPLICATIONS

This application claims the benefit of U.S. Provisional Patent Application 62/579,582, by Ryan, et al., “Personalized Interaction And Navigation System,” filed Oct. 31, 2017 which is hereby incorporated by reference in its entirety.

### BACKGROUND

When working in a particular computing environment, how easily a user is able to navigate between different documents or applications the user is accessing can impact both the user's experience and productivity. The greater the ease or flexibility with which the user is able to customize the navigational experience, the better the user's experience with the computing environment will be and the more the user's productivity can be increased.

### BRIEF DESCRIPTION OF THE DRAWINGS

The accompanying drawings are incorporated herein and form a part of the specification.

FIG. 1 is a block diagram showing example operations related to providing a personalized interaction and navigation system, according to some embodiments.

FIGS. 2A-2D illustrate example screenshots related to providing a personalized interaction and navigation system, according to some embodiments.

FIG. 3 is a flowchart illustrating a process for providing a personalized interaction and navigation system, according to some embodiments.

FIG. 4 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for a personalized interaction and navigation system.

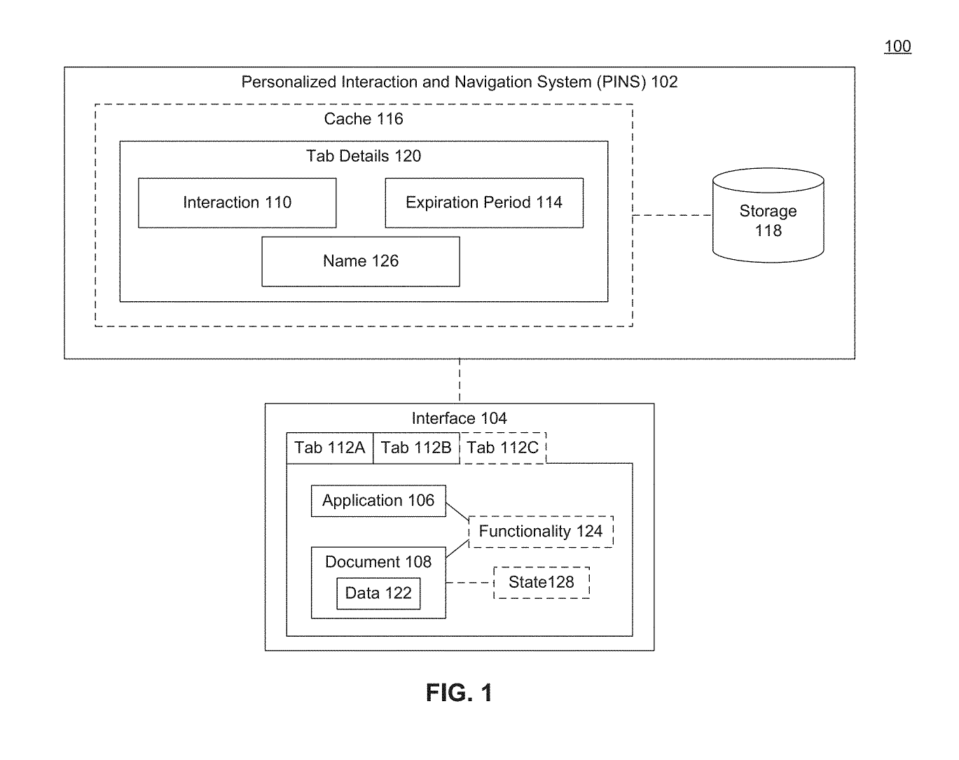

FIG. 1 is a block diagram 100 showing example operations related to a personalized interaction and navigation system (PINS) 102, according to some embodiments. PINS 102 may automatically adjust navigational elements (tabs 112) within an interface 104 and manage memory (e.g., cache 116 and storage 118) based on how a user is interacting with interface 104.

A tab 112 may be a navigational shortcut accessible via interface 104 that enables a user to have quick access to a particular application 106, document 108, data 122, or functionality 124. Tab 112 may include a button, menu item, link, or other visual indictor that may be displayed on and selected from interface 104. In an embodiment, interface 104 may be pre-configured with one or more tabs 112A, 112B that are accessible to a particular user. For example, a system administrator may have pre-configured tabs 112A, 112B to provide access to commonly used or previously accessed applications 106 or documents 108 for a particular employee of an organization. However, during the course of using interface 104, the employee may access other applications 106, documents 108, data 122, and perform functionality 124 not included in one of the existing tabs 112A, 112B.

PINS 102 may monitor how the employee (or other user) is interacting with interface 104, including one or more applications 106 and/or documents 108 which may be directly or indirectly accessible via interface 104. Based on the detected interactions 110, PINS 102 may determine whether or not, or how to automatically (e.g., without a specific user request) add a new tab 112C to interface 104 (or adjust existing tabs 112A, 112B). For example, PINS 102 may determine that the user is accessing a spreadsheet application 106 to access a sales report 108. PINS 102 may further detect that within the sales report 108, the user is looking at data 122 of a particular client, and updating the data 124. PINS 102 may then add any of the spreadsheet application 106, sales report 108, client data 122, and/or the functionality to update the data 124 to one or more new tabs 112C (or sub-tabs or entries under a particular tab 112).

Using the new tab 112C, a user may then directly access the corresponding application 106, document 108, data 122, or functionality 124 rather following a traditional roadmap. For example, rather than first opening an application, then opening a document 108, then scrolling down to a particular portion of the data, and then selecting or performing the functionality, PINS 102 may provide a tab 112C that directly provides the user access to functionality 124 or may execute the functionality 124. Then for example, rather than wasting time and processing cycles waiting for user input, PINS 102 can direct one or more computing devices which data, document, application, and functionality to open and execute all at once (or without intervening user input which may cause delays and wasted computing cycles, in prompting a user and receiving input).

In an embodiment, PINS 102 may maintain any new tabs 112C created for interface 104 within a cache 116 for the duration of a particular computing session (or until the end of an expiration period 114). At the end of the expiration period 114 (computing session) PINS 102 may automatically (without user request) delete the new tab 112C both from interface 104 and from the corresponding cache 116, thus automatically freeing up both display area and cache space.

In an embodiment, PINS 102 may provide the user an option to make the new (temporary) tab 112C permanent or otherwise extend the expiration period 114 beyond the current computing session. If PINS 102 receives a request to extend the expiration period 114 beyond the current computing session, then tab details 120 about the new tab 112C may be stored in storage 118. Then, for example, the next time the user logs in to interface 104, the new tab 112C will automatically appear with the previously existing tabs 112A, 112B. In an embodiment, PINS 102 may automatically (without receiving a specific request) remove the new tab 112C from the interface 104 (and corresponding memory area) as a default option unless the user an explicitly requests to maintain the new tab 112C beyond the instant computing session.

Interface 104 may be a customizable or personalizable user interface that enables access for multiple users to an operating system, enterprise system, or cloud computing system. For example, as noted above, an administrator may initially configure interface 104 with tabs 112A and 112B which may provide access to commonly used applications 106 or documents 108. However, PINS 102 may personalize or otherwise enable users to personalize their interface 104 based on which other applications 106, documents 108, data 122, and/or functionality 124 they use. PINS 102 may monitor the user interactions with interface 104 and automatically update tabs 112 of interface 104 based on both detected user interactions 110 and user preferences (e.g., requests to rename tabs 126 and/or extend the expiration period 114).

In an embodiment, PINS 102 may automatically name tabs 112. PINS 102 may enable a user to rename, choose a name, or provide a new default name 126 at any time. In addition to PINS 102 automatically selecting interactions 110 for which to create new tabs 112C. In an embodiment, a user may request a new tab 112 to be created based on an open application 106, open document 108, or currently accessed data 122. In an embodiment, PINS 102 may create new tabs 112C based on automatically detected interactions 110 (without specific user request) and/or on a specific user request.

In an embodiment, two different users of a system may have two different interfaces 104 individually configured for them based on how they interact with interface and which applications 106 and documents 108 they use or access. As such, changes to the interface 104 for a first user may not appear on the interface 104 of a second user. However, in an embodiment, a manager may have an option to propagate changes from their interface 104 to the interface 104 of one or more of the employees being managed. For example, the manager may select which new tabs 112c and/or sub-tabs are propagated to which employees.

PINS 102 may monitor what functionality 124 a user performing via interface 104. Example functionality 124 includes opening applications 106 to read, write, modify, or otherwise access various documents 108 and/or data 122. These user accesses may be recorded as interactions 110. An interaction 110 may be an indication of any user action or interaction with any of the programs, applications, documents, data., or apps accessible from interface 104, stored locally or across a network.

An example interaction 110 may indicate that a sales document 108 of a particular spreadsheet program 1006 was modified, is being modified, or is being requested to be modified by a user. In an embodiment, interaction 110 may include which records 122 of the sales document 108 were modified 124. Or for example, interaction 110 may indicate whether the sales document 108 was printed out 124 or e-mailed 124 to one or more other users. Any information determined from interaction 110 may be included in or as part of a tab 112 or sub-tab (entry within a tab 112).

PINS 102 may compare interaction 110 to a list of previously configured or populated tabs 112A, 112B (each of which may include sub-tab elements). If interaction 110 corresponds to an existing tab 112A, 112B, then no new tab 112C may be added as a result of the interaction 110. Instead, a new entry or sub-tab may be added to the existing tab 112A, 112B. For example, if interaction 110 is opening a cloud-based word processing application 116, and tab 112A corresponds to the word processing application 116, then no new tab may be added. If, however, interaction 110 is opening a new (not recently accessed) document of the word processing application 116, then PINS 102 may add a new sub-tab (not shown) under tab 1124 corresponding to the opened document. Or, for example, if the document already exists in a list of recently viewed documents, the accessed document may be reordered and moved further up the list (indicating a more recent access)

Tabs 112 and sub-tabs may be shortcuts enabling a user to navigate between applications 106 and/or documents 108 via interface 104. A sub-tab may be any entry below the main heading of a navigational tab 112. Applications 106 may include apps or applications (including local, web, and cloud-based programs) that are accessible via interface 104. Example applications 106 include e-mail, web browser, file directories, spreadsheet, database, word processing, image editor, or other applications.

Documents 108 may include any files, images, business objects, videos, or other documents accessible to a user via interface 104. Documents 108 may include locally stored or documents stored on a cloud computing system or across one or more servers or other computing devices. In an embodiment, application 106 may correspond to or include a document type. For example, an image editor 106 may be enable a user to read, access, or modify both .jpg and .gif images, which may each corresponding to different types of image documents 108. In an embodiment, PINS 102 may include a first tab 112A for .jpg images, and a second tab 112B for .gif images. Or, for example, PINS 102 may create a new tab 112C for the image editor, including a first sub-tab for .jpg images, and a second sub-tab for .gif images. In an embodiment, document 108 may reference a particular table of a database 106. Data 122 may include particular records of the table 108.

In an embodiment, PINS 102 may create tabs 112C that provide a user access to documents 108 or data 112 in a particular state 128. State 128 may include, for example, a snapshot of the data 112 or document 108 at a particular date and time. For example, if interaction 110 indicates that a user is reading 124 client X data 122 from a sales order document 108 on September 24^{th}, then PINS 102 may take a take a snapshot of the data being read 124 and include make the snapshot (of the data on September 24^{th}) accessible via a tab 112C or sub-tab.

As noted above, in an embodiment, when PINS 102 creates a new tab 112C responsive to an interaction 110, PINS 102 may store the tab details 120 may be in cache 116. In an embodiment, tab details 120 may include the captured snapshot of the state 128. Cache 116 may include volatile, short-term memory accessible for displaying image elements on interface 104. At the end of expiration period 114 (which may be the instant or current computing session), PINS 102 may automatically remove, garbage collect, or mark for deletion tab details 120 from cache 116, thus making the space available for usage. Furthermore, through cache 116 management, PINS 102 avoids making more computationally expensive reads and writes to storage 118 when they are not needed for storing tab details 120 information for new tabs 112C.

PINS 102 may improve processing and resource usage by automatically managing manage memory (cache 116 and storage 118) usage for the creation and removal of new temporary and permanent tabs 112. For example, as just noted, when a new (temporary) tab 112C with an in-session expiration period 114 is created by PINS 102, tab details 120 pertaining to the tab 112C may be stored in cache 116. However, if PINS 102 receives or detects a user indication to maintain the temporary tab 112C beyond the instant computing session (e.g., expiration period 114), then PINS 102 may write tab details 120 to storage 118. Then, for example, the next time the user logs into interface 104, the previously temporary tab 112C will appear as a permanent tab 112A, B. Then at the end of expiration period 114 (without a specific, subsequent request) PINS 102 may remove or mark for deletion the tab details 120 from storage 118, thus making the space available for usage.

In an embodiment, a user can set expiration period 114 to any time period, length of time, or number of computing sessions, including an indefinite period of time (e.g., until receipt of a user or administrator request to delete). If expiration period 114 is set to expand beyond the current computing session, then PINS 102 may move tab details 120 into storage 118.

A computing session may terminate when a user's machine (being used to access or display interface 104) is restarted, when a server (providing interface 104) is restarted, when the user closes interface 104, when a user logs out of a system being accessed via. interface 104, or after predetermined time period (e.g., one hour, midnight of the same day, or 24 hours from when the tab was created).

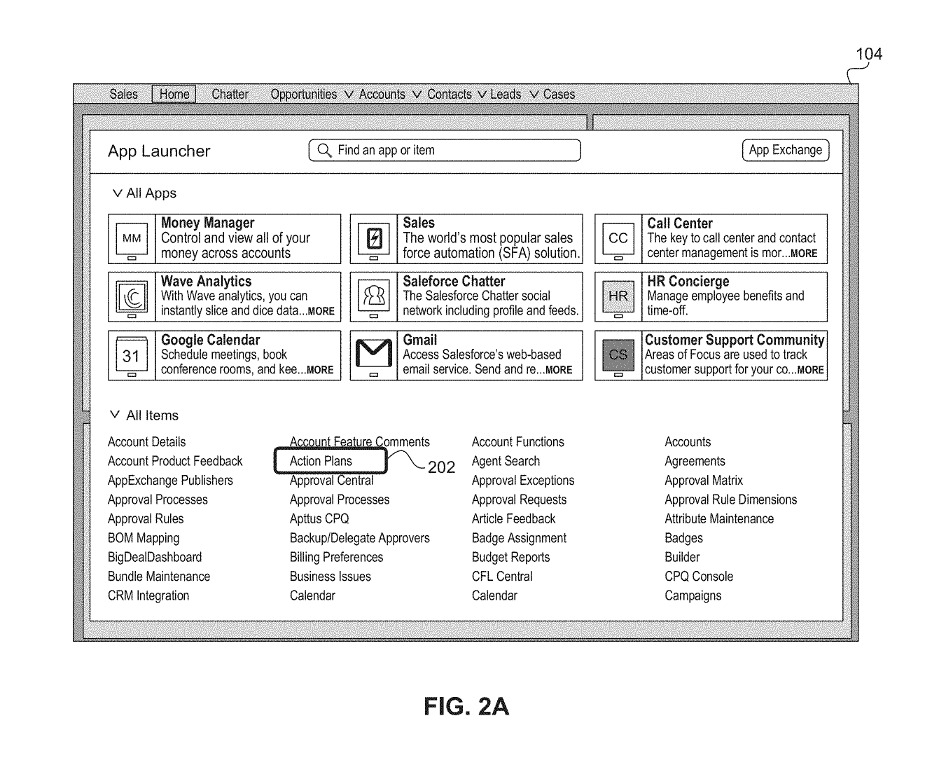

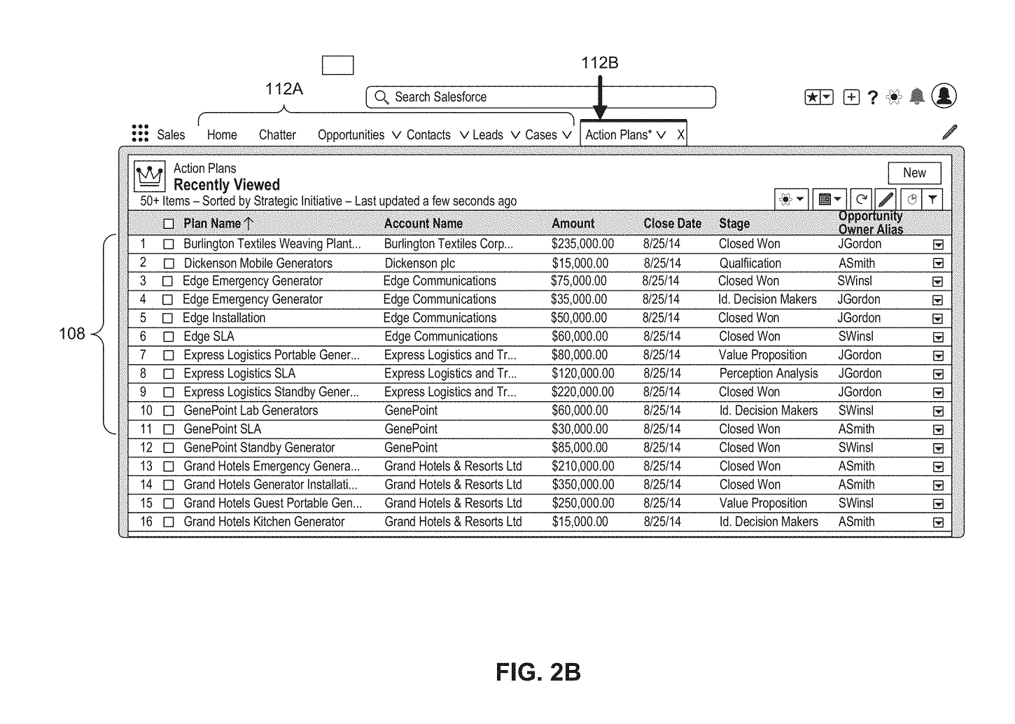

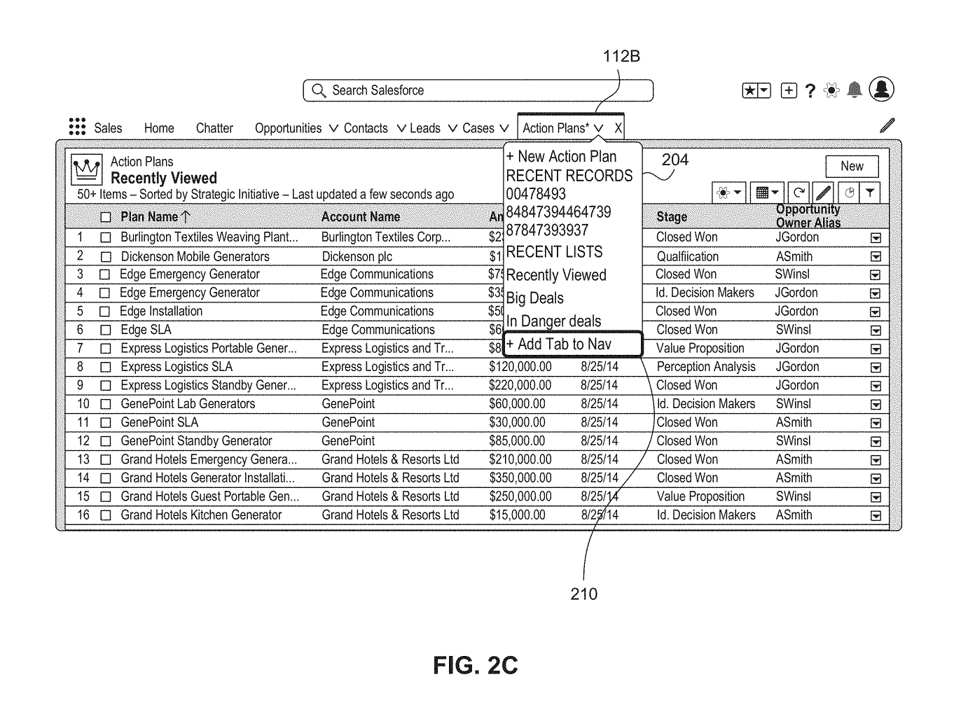

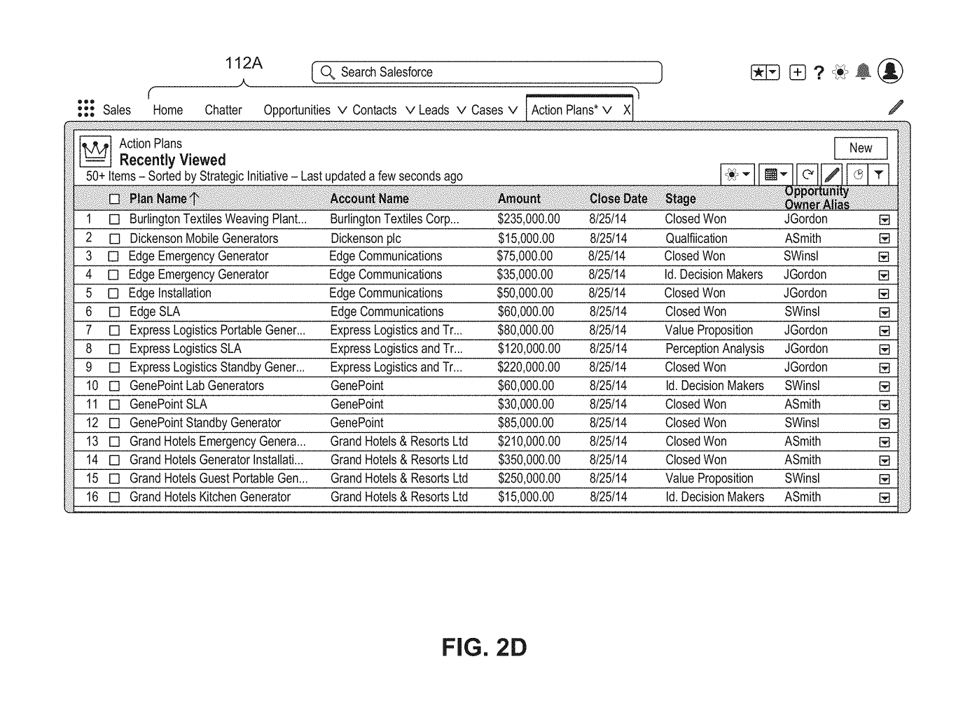

FIGS. 2A-2D illustrate example screenshots related to providing a personalized. interaction and navigation system (PINS) 102, according to some embodiments. FIG. 2A illustrates an example interface 104 from which a user may select any number of different applications 106 or documents 108 to access. In the example shown, a user may select 202 “Action Plans,” in an embodiment, Action Plans may be a description that refers to a set or group of documents 108, each of which may contain or be part of one or more action plans.

In FIG. 2B, PINS 102 may receive an interaction 202 (from FIG. 2A) including an indication that the user has selected Action Plans. PINS 102 may compare the interaction 202 to the open or previously created tabs 112A to determine whether or not a new tab needs to be opened or whether to add Action Plans 202 as a sub-tab entry. For example, if an Action Plans tab already existed in the previously created tabs 112A, then no new tab may be created by PINS 102. However, in the example shown, no Action Plans tab 112A exists, so PINS 102 may create a new temporary tab 112B on interface 104.

The new tab 112E may be set as the active tab, and interface 104 may provide access to various Action Plan documents 108 (and/or data 122). A user may then use tab 112B to view, access, or modify documents 108 and/or data 122 related to the “Action Plans” set of documents.

FIG. 2C illustrates sub-tabs 204 that may be added to the new Action Plans 112B tab. The sub-tabs 204 may include a “Recent Records” or “Recent Documents” 122 section that enables access to particular records or data from particular Action Plan documents 108 that were previously read, searched for, modified, or otherwise accessed. In an embodiment, sub-tabs 204 may include links to either current data or snapshots of the documents/data at a particular time of access. In an embodiment, sub-tabs 204 corresponding to snapshots may indicate a date/time of the snapshot.

In an embodiment, if a user makes particular selections within Action Plans (accessing or modifying particular action plans or documents 108), PINS 102 may detect these interactions 110 and may add them as sub-tabs, entries, or short-cuts underneath the general tab “Action Plans.” For example, if the user selects “Edge Installation,” then “Edge Installation,” may automatically be added as a shortcut or sub-tab 204 under the Action Plans tab 112B. Or, for example, if the user prints all the documents with the word GenePoint, then the print functionality 124 may be added as a shortcut under the Action Plans tab 112B. In another embodiment, a print functionality tab 112B may be added, which may include as sub-tabs any documents recently printed.

In the example shown, a user may make a selection 210 to make the temporary tab 112B a permanent tab or otherwise extend the expiration period 114 beyond the current computing session. In an embodiment, the selection 210 may trigger PINS 102 to make the expiration period 114 indefinite or to a maximum time period (as may be specified by a system administrator). Tab details 120 may then be stored in storage 118. In another embodiment, the user may be provided the option of manually entering the expiration period 114. In an embodiment, the default expiration period 114 may be at the end of the instant computing session.

FIG. 2D illustrates an example of the previously temporary tab 112B being made one of the permanent tabs 112A. The Action Plans tab however may remain highlighted to indicate it is the active tab and that the displayed data 122 or documents 108 of interface 104 pertain to the active tab.

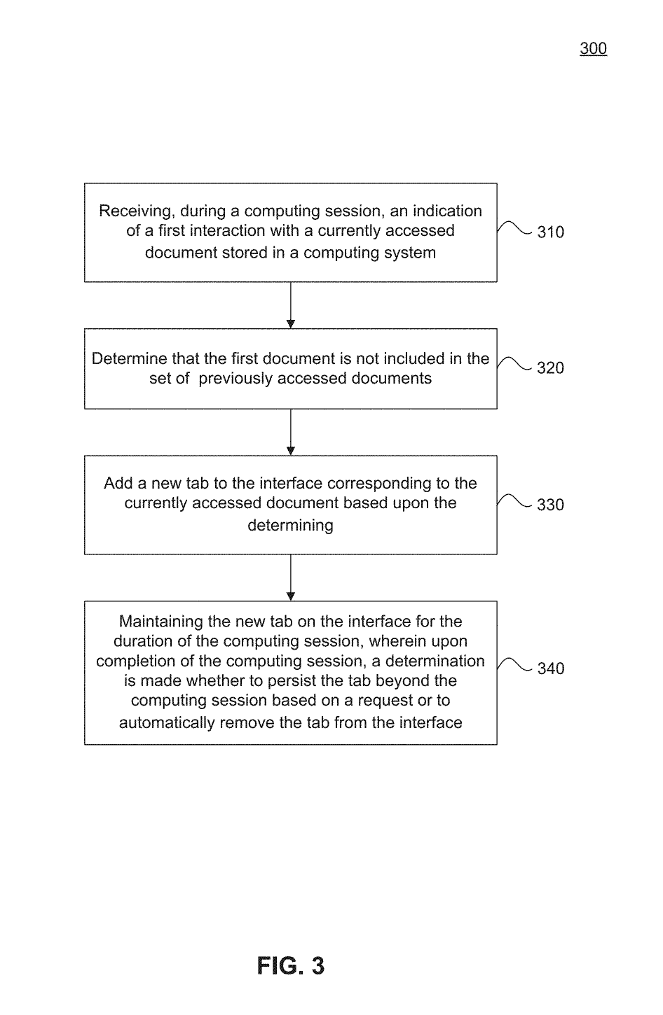

FIG. 3 is a flowchart illustrating a process 300 for providing migration and validation, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

At 310, an indication of a first interaction with a currently accessed document stored in a computing system is received during a computing session. In an embodiment, a computing session may begin when a user logs in to a system, such as an enterprise or cloud computing system, and interface 104 is displayed on the user's device. In an embodiment, the computing session may end when the user logs out (or is otherwise logged out) of the system. The computing session may end for example, at the end of a specified period of time, when interface 104 is closed on a user's local device, or when a user's device is turned off or restarted.

During the course of the computing session, the user may access a particular document 108. Document 108 may be stored on the cloud across one or more computing devices or servers remote from a computing device from which the user is accessing interface 104. In an embodiment, document 108 may be accessed or accessible by multiple users simultaneously.

At 320, it is determined that the first document is not included in the set of previously accessed documents. For example, as shown in FIG. 1, interface 104 may include a set of previously configured or accessed applications 106 or documents 108 that are accessible via tabs 112A and 112B. PINS 102 may determine that a selected application 106 or document 108 is not accounted for in tabs 112A. For example, in FIG. 2A, a user may select Active Plans 202 and PINS 102 may determine whether or not Active Plans is already included in tabs 112A, 112B.

At 330, a new tab is added to the interface corresponding to the currently accessed document based upon the determining. For example, as shown in FIG. 2B, new tab 112B may be added to interface 104 for Active Plans.

At 340, the new tab is maintained on the interface for the duration of the computing session, wherein upon completion of the computing session, a determination is made whether to persist the tab beyond the computing session based on a request or to automatically remove the tab from the interface. For example, PINS 102 may automatically delete the new tab 112C (as shown in FIG. 2B) from a cache 116 at the end of a computing session. However, if a user selects or opts to maintain the new tab 112 beyond the computing session (selection 210 of FIG. 2C), then PINS 102 may store tab details 120 in longer term storage 118. The, for example, the next time the user logs in to interface (or in the next computing session), the previously added tab 112B will show up as one of the permanent tabs 112C (as shown in FIG. 2D).

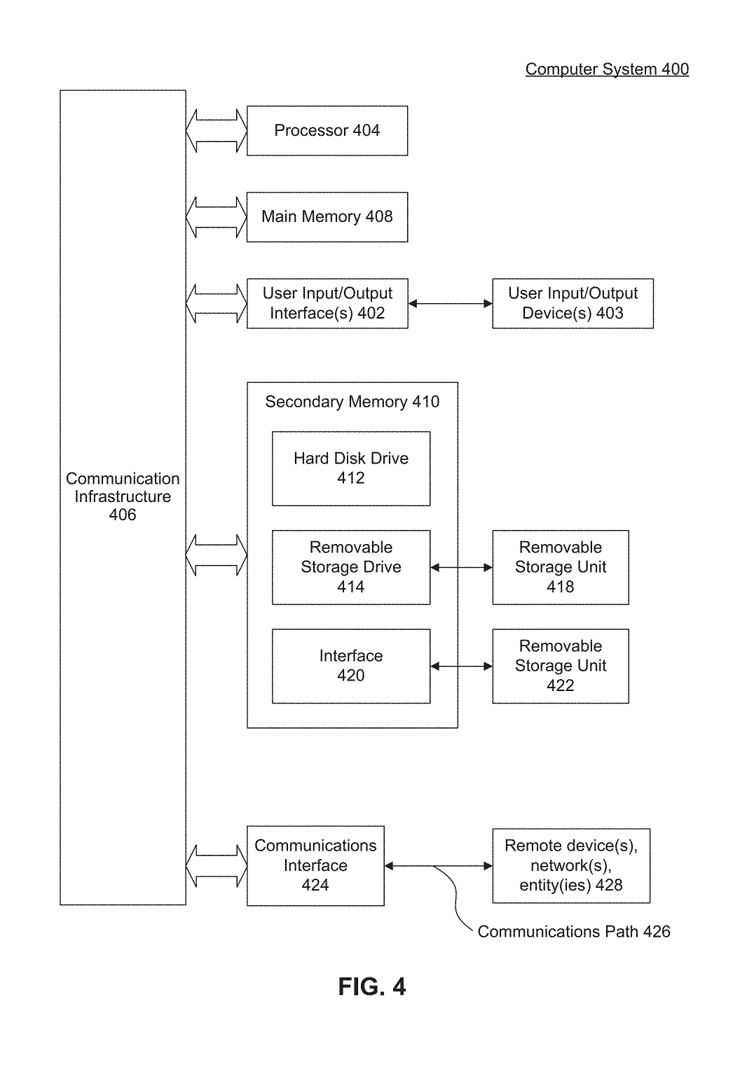

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos. etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/ any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method, comprising:
receiving, during a computing session, an indication of a first interaction with a currently accessed document stored in a computing system, wherein an interface to the computing system displays one or more tabs corresponding to a set of one or previously accessed documents;
determining that the first document is not included in the set of previously accessed documents;
adding a new tab to the interface corresponding to the currently accessed document based upon the determining, wherein the new tab is stored in a cache; and
maintaining the new tab on the interface for the duration of the computing session, wherein upon completion of the computing session, a determination is made whether to persist the tab beyond the computing session based on a request or to automatically remove the tab from the interface and the cache.

2. The method of claim 1, wherein the computing system is a cloud computing system, and wherein the first document is accessible to multiple users simultaneously.

3. The method of claim 1, wherein the determining comprises:
determining a document type corresponding to the first the document, wherein each of a plurality of tabs of the interface corresponds to different document types;
comparing the document type of the first document to the document types corresponding to the plurality of tabs; and
determining, based upon the comparing, that the document type of the first document is different the document types corresponding to the plurality of tabs.

4. The method of claim 1, further comprising:
receiving an indication to maintain the new tab beyond the computing session.

5. The method of claim 4, wherein the maintaining comprises:
maintaining the new tab on the interface for the duration of the computing session and during one or more subsequent computing sessions beyond the completion of the computing session including the first user interaction; and
storing the new tab in non-volatile storage.

6. The method of claim 1, further comprising:
determining a user access to a particular record of the first document; and
adding the user access to the particular record to the new tab.

7. The method of claim 1, wherein the interface includes a plurality of previously configured tabs for a plurality of users of a group, and wherein the new tab is added to the interface for a first one of the plurality of users of the group associated with the computing session and is not added to an interface of a second one of the users of the group not associated with the computing session.

8. The method of claim 1, wherein the interaction comprises a read access to data on a particular date and time, and wherein the new tab includes a shortcut to a snapshot of the data on the particular date and time.

9. A system, comprising:
a memory; and
at least one processor coupled to the memory and configured to:
receive, during a computing session, an indication of a first interaction with a currently accessed document stored in a computing system, wherein an interface to the computing system displays one or more tabs corresponding to a set of one or previously accessed documents;
determine that the first document is not included in the set of previously accessed documents;
add a new tab to the interface corresponding to the currently accessed document based upon the determining, wherein the new tab is stored in a cache; and
maintain the new tab on the interface for the duration of the computing session, wherein upon completion of the computing session, a determination is made whether to persist the tab beyond the computing session based on a request or to automatically remove the tab from the interface and the cache.

10. The system of claim 9, wherein the computing system is a cloud computing system, and wherein the first document is accessible to multiple users simultaneously.

11. The system of claim 9, wherein the processor is further configured to:
determine a document type corresponding to the first the document, wherein each of a plurality of tabs of the interface corresponds to different document types;
compare the document type of the first document to the document types corresponding to the plurality of tabs; and
determine, based upon the comparison, that the document type of the first document is different the document types corresponding to the plurality of tabs.

12. The system of claim 9, wherein the processor is further configured to:
receive an indication to maintain the new tab beyond the computing session.

13. The system of claim 12, wherein the processor configured to maintain is configured to:
maintain the new tab on the interface for the duration of the computing session and during one or more subsequent computing sessions beyond the completion of the computing session including the first user interaction; and
store the new tab in non-volatile storage.

14. The system of claim 9, wherein the processor is further configured to:
determine a user access to a particular record of the first document; and
add the user access to the particular record to the new tab.

15. The system of claim 10, wherein the interface includes a plurality of previously configured tabs for a plurality of users of a group, and wherein the new tab is added to the interface for a first one of the plurality of users of the group associated with the computing session and is not added to an interface of a second one of the users of the group not associated with the computing session.

16. The system of claim 10, wherein the interaction comprises a read access to data on a particular date and time, and wherein the new tab includes a shortcut to a snapshot of the data on the particular date and time.

17. A non-transitory computer-readable device having instructions stored on a memory thereon that when executed by at least one processor of the device, causes the at least one processor to perform operations comprising:
receiving, during a computing session, an indication of a first interaction with a currently accessed document stored in a computing system, wherein an interface to the computing system displays one or more tabs corresponding to a set of one or previously accessed documents;
determining that the first document is not included in the set of previously accessed documents;
adding a new tab to the interface corresponding to the currently accessed document based upon the determining, wherein the new tab is stored in a cache; and
maintaining the new tab on the interface for the duration of the computing session, wherein upon completion of the computing session, a determination is made whether to persist the tab beyond the computing session based on a request or to automatically remove the tab from the interface and the cache.

18. The device of claim 17, wherein the computing system is a cloud computing system, and wherein the first document is accessible to multiple users simultaneously.

19. The device of claim 19, wherein the at least one processor that determines performs operations comprising:
determining a document type corresponding to the first the document, wherein each of a plurality of tabs of the interface corresponds to different document types;
comparing the document type of the first document to the document types corresponding to the plurality of tabs; and
determining, based upon the comparing, that the document type of the first document is different the document types corresponding to the plurality of tabs.

20. The device of claim 17, wherein the at least one processor further performs operations comprising:
receiving an indication to maintain the new tab beyond the computing session.
